(19) United States
(12) Patent Application Publication
(10) Pub. No.: US 2019/0036279 A1
(43) Pub. Date: Jan. 31, 2019

(54) WIRELESS TRANSMISSION ASSEMBLY AND HOUSEHOLD APPLIANCE SYSTEM

(71) Applicant: POWERTECH INDUSTRIAL CO., LTD., NEW TAIPEI CITY (TW)

(72) Inventors: YU-LUNG LEE, NEW TAIPEI CITY (TW); TUN-CHI YU, TAIPEI CITY (TW)

(21) Appl. No.: 15/837,676

(22) Filed: Dec. 11, 2017

(30) Foreign Application Priority Data
Jul. 28, 2017 (TW) 106125517

(51) Int. Cl. H01R 13/66; H01R 24/28; H01R 24/76

(52) U.S. Cl. CPC H01R 13/6691; H01R 24/28; H01R 2103/00; H01R 13/6683; H01R 24/76

(57) ABSTRACT

A wireless transmission assembly includes a power cord and a communication outlet. The power cord includes a plurality of plug pins, an AC wire set, a transceiver, and a signal wire. Two opposite ends of the AC wire set are respectively connected to the plug pins and a mating electronic device. Two opposite ends of the signal wire are respectively connected to the transceiver and the mating electronic device. The communication outlet includes a plurality of socket pins, a communicator, and a wireless module. The socket pins are detachably connected to the plug pins. The communicator is arranged adjacent to the socket pins and is configured to cooperate with the transceiver in a wireless signal connection for getting information about the mating electronic device. The wireless module is electrically connected to the communicator, and is configured to transmit the information from the communicator to the external electronic device.

### BACKGROUND OF THE INVENTION

### 1. Field of the Invention

The present disclosure relates to a transmission assembly; in particular, to a wireless transmission assembly and a household appliance system.

### 2. Description of Related Art

The structure of a conventional electronic device (e.g., a refrigerator, an oven, an air conditioner or other household appliances), which is provided without any communication function, is not suitable to add a communication module. Thus, if the conventional electronic device needs to add a communication module thereto, the overall structure of the conventional electronic device has to be adjusted or changed. Moreover, the housing of the conventional electronic device is usually made of a material (e.g., metal), which interferes with or shields an electromagnetic signal, so that when a communication module is added to the conventional electronic device, the performance of the communication module will be reduced.

### SUMMARY OF THE INVENTION

The present disclosure provides a wireless transmission assembly and a household appliance system to enable conventional electronic devices (e.g., conventional household appliances) to possess a wireless communication function without changing the structure thereof.

The present disclosure discloses a wireless transmission assembly, which includes a power cord and a communication outlet. The power cord includes a plug, a plurality of plug pins, an alternating current (AC) wire set, a transceiver, and a signal wire. Each of the plug pins is partially embedded in the plug. One of two opposite ends of the AC wire set is embedded in the plug and is connected to the plug pins, and the other end of the AC wire set is configured to electrically connect to a mating electronic device. The transceiver is embedded in the plug. One of two opposite ends of the signal wire is embedded in the plug and is electrically connected to the transceiver, and the other end of the signal wire is configured to electrically connect to the mating electronic device. The communication outlet includes a plurality of socket pins, a communicator, and a wireless module. The socket pins are detachably connected to the plug pins for transmitting an AC power to the power cord. The communicator is arranged adjacent to the socket pins. The communicator is configured to cooperate with the transceiver in a wireless signal connection for getting information about the mating electronic device. The wireless module is electrically connected to the communicator. The wireless module is configured to transmit the information from the communicator to an external electronic device.

The present disclosure also discloses a household appliance system for being wirelessly connected to an external electronic device. The household appliance system includes a household appliance and a wireless transmission assembly. The wireless transmission assembly is configured to wirelessly connect the household appliance to the external electronic device. The wireless transmission assembly includes a power cord and a communication outlet. The power cord includes a plug, a plurality of plug pins, an AC wire set, a transceiver, and a signal wire. Each of the plug pins is partially embedded in the plug. One of two opposite ends of the AC wire set is embedded in the plug and is connected to the plug pins, and the other end of the AC wire set is configured to electrically connect to the household appliance. The transceiver is embedded in the plug. One of two opposite ends of the signal wire is embedded in the plug and is electrically connected to the transceiver, and the other end of the signal wire is configured to electrically connect to the household appliance. The communication outlet includes a plurality of socket pins, a communicator, and a wireless module. The socket pins are detachably connected to the plug pins for transmitting an AC power to the power cord. The communicator is arranged adjacent to the socket pins. The communicator is configured to cooperate with the transceiver in a wireless signal connection for getting information about the household appliance. The wireless module is electrically connected to the communicator. The wireless module is configured to transmit the information from the communicator to the external electronic device.

In summary, the structure and connection of the power cord and the communication outlet in the present disclosure are improved to enable a household appliance (or a mating electronic device) which is connected to the power cord to possess a wireless communication function, so that the main structure of the household appliance (or the mating electronic device) can be maintained, and a user can control the household appliance (or the mating electronic device) easily.

In order to further appreciate the characteristics and technical contents of the present disclosure, references are hereunder made to the detailed descriptions and appended drawings in connection with the present disclosure. However, the appended drawings are merely shown for exemplary purposes, and should not be construed as restricting the scope of the present disclosure.

### BRIEF DESCRIPTION OF THE DRAWINGS

FIG. 1 is a first functional block view showing a household appliance system according to the present disclosure;

FIG. 2 is a second functional block view showing the household appliance system according to the present disclosure;

FIG. 3 is a perspective view showing the household appliance system according to a first embodiment of the present disclosure;

FIG. 4 is a perspective view showing the household appliance system according to a second embodiment of the present disclosure;

FIG. 5 is a functional block view showing the household appliance system according to a third embodiment of the present disclosure; and

FIG. 6 is a functional block view showing the household appliance system according to a fourth embodiment of the present disclosure.

### DETAILED DESCRIPTION OF THE PREFERRED EMBODIMENTS

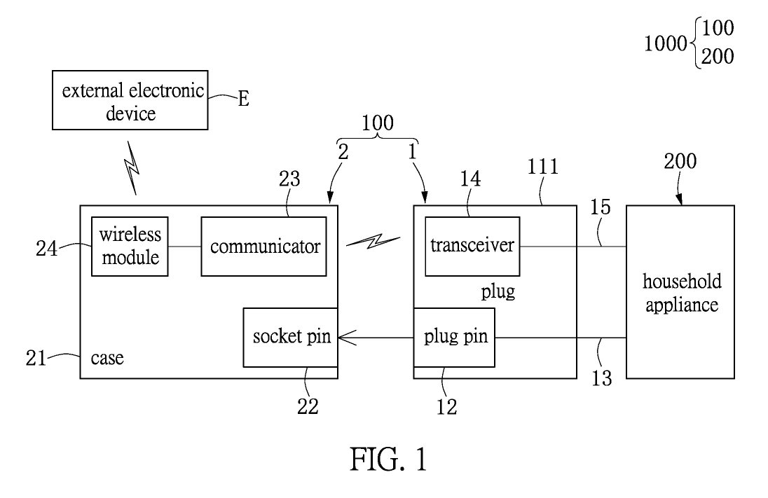

Reference is made to FIGS. 1 to 6, which illustrate the present disclosure. References are hereunder made to the detailed descriptions and appended drawings in connection with the present disclosure. However, the appended drawings are merely provided for exemplary purposes, and should not be construed as restricting the scope of the present disclosure.

Reference is first made to FIG. 1, which illustrates a household appliance system 1000 for wirelessly connecting to an external electronic device E (e.g., a computer, a smart phone, or a cloud host). The household appliance system 1000 includes a household appliance 200 and a wireless transmission assembly 100 configured to wirelessly connect the household appliance 200 to the external electronic device E. Moreover, the household appliance 200 (e.g., a refrigerator, an oven, an air condition, an electric water heater, an audio and video equipment, or other devices) in the present disclosure cannot wirelessly connect to any external electronic device E by itself. That is to say, a household appliance, which can wirelessly connect to any external electronic device E by itself, is not the household appliance 200 in the present disclosure.

It should be noted that the wireless transmission assembly 100 in FIG. 1 is applied to the household appliance system 1000, but the present disclosure is not limited thereto. In other words, the wireless transmission assembly 100 can be independently applied to a mating electronic device which can be a household appliance or a non-household appliance. In order to clearly describe the present disclosure, the mating electronic device cooperated with the wireless transmission assembly 100 takes the household appliance 200 for example.

The wireless transmission assembly 100 includes a power cord 1 and a communication outlet 2 cooperated with the power cord 1. One of two opposite ends of the power cord 1 is detachably connected to the household appliance 200, and the other end of the power cord 1 is detachably inserted into the communication outlet 2. The following description discloses the structure and connection of each component of the wireless transmission assembly 100.

As shown in FIG. 1, the power cord 1 includes a plug 111, a plurality of plug pins 12 each partially embedded in the plug 111, an alternating current (AC) wire set 13, a transceiver 14 embedded in the plug 111, and a signal wire 15. One of two opposite ends of the AC wire set 13 is embedded in the plug 111 and is connected to the plug pins 12, and the other end of the AC wire set 13 is configured to electrically connect to the household appliance 200. One of two opposite ends of the signal wire 15 is embedded in the plug 111 and is electrically connected to the transceiver 14, and the other end of the signal wire 15 is configured to electrically connect to the household appliance 200.

The communication outlet 2 includes a plurality of socket pins 22 detachably connected to the plug pins 12, a communicator 23 arranged adjacent to the socket pins 22, and a wireless module 24 electrically connected to the communicator 23. The communicator 23 is configured to cooperate with the transceiver 14 in a wireless signal connection for getting information about the household appliance 200. The wireless module 24 is configured to transmit the information from the communicator 23 to the external electronic device E.

It should be noted that the communication outlet 2 is configured to electrically connected to an AC power, which is provided by an electricity company, and the communication outlet 2 can be any kind of outlet (e.g., an extension outlet, a wall outlet, or an adapter outlet), but the present disclosure is not limited thereto. Moreover, the signal transmission between the power cord 1 and the communication outlet 2 in the present embodiment is implemented only by using the wireless signal connection between the transceiver 14 and the communicator 23. That is to say, the components, which transmit signal by using cables or a touching manner, are not the power cord 1 and the communication outlet 2 of the present embodiment.

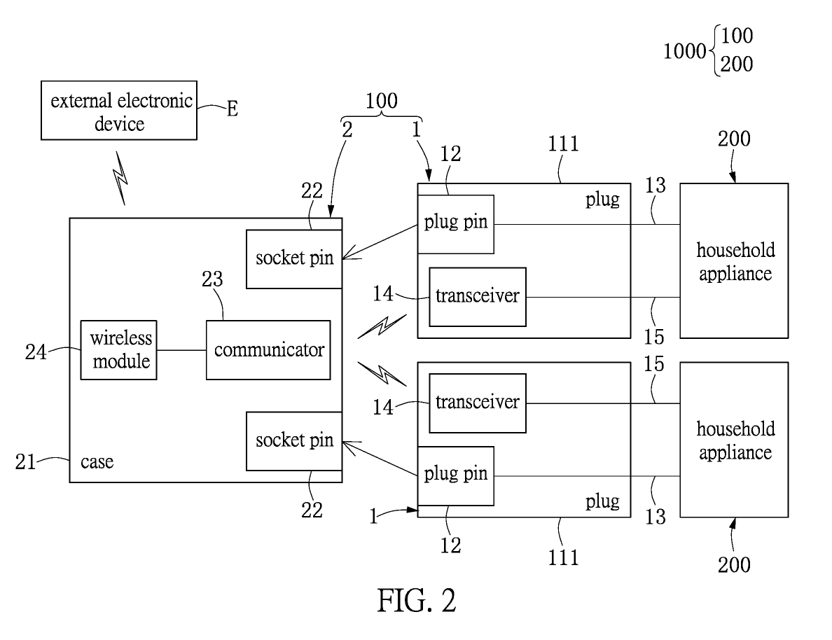

In addition, the wireless transmission assembly 100 as shown in FIG. 1 adapts one communicator 23 to cooperate with one transceiver 14, but the present disclosure is not limited thereto. For example, as shown in FIG. 2, the wireless transmission assembly 100 can adapt one communicator 23 to cooperate with a plurality of transceivers 14. That is to say, the communicator 23 can be cooperated with more than one transceiver 14 in a wireless signal connection.

Thus, the structure and connection of the power cord 1 and the communication outlet 2 in the present embodiment are improved to enable the household appliance 200 which is connected to the power cord 1 to possess a wireless communication function, so that the main structure of the household appliance 200 can be maintained, and a user can control the household appliance 200 easily.

The main features of the wireless transmission assembly 100 have been disclosed in the above description, and the wireless transmission assembly 100 can be adjusted to form different embodiments by using the main features, so that the present disclosure cannot disclose all possible embodiments. Accordingly, the following description just discloses some embodiments each using the above main features for further describing the wireless transmission assembly 100, but the present disclosure is not limited thereto.

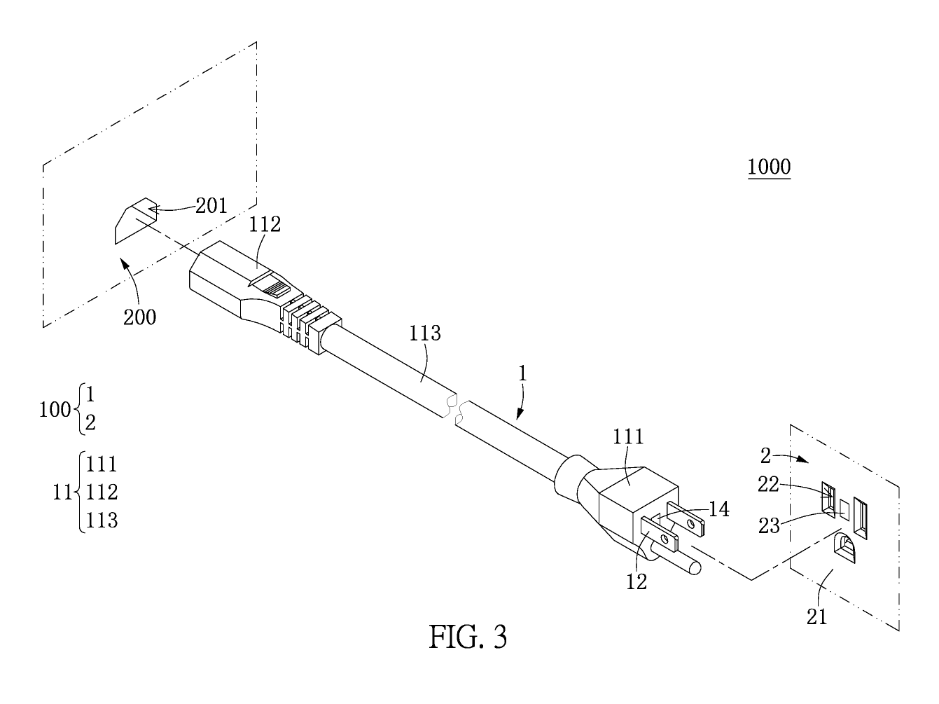

As shown in FIGS. 1 and 3, the power cord 1 includes an insulating body 11 having the plug 111, an wire connector 112, and a tubular insulating layer 113, the last of which is connected to the plug 111 and the wire connector 112. The two opposite ends of the AC wire set 13 are respectively embedded in the plug 111 and the wire connector 112, and the other portion of the AC wire set 13 is embedded in the insulating layer 113. The two opposite ends of the signal wire 15 are respectively embedded in the plug 111 and the wire connector 112, and the other portion of the signal wire 15 is embedded in the insulating layer 113. Thus, the AC wire set 13 can be insulated from the signal wire 15 by the insulating body 11.

Moreover, the household appliance 200 includes an inserting port 201. The wire connector 112 is detachably inserted into the inserting port 201, and the ends of the AC wire set 13 and the signal wire 15 embedded in the wire connector 112 are electrically connected to the household appliance 200 through the inserting port 201. For example, the ends of the AC wire set 13 and the signal wire 15 embedded in the wire connector 112 are respectively connected to a plurality of conductive terminals (not shown), and the conductive terminals are electrically connected to the inserting port 201.

Thus, the household appliance 200, which is similar to any conventional household appliance provided without wireless communication function, can increase its value without changing the main structure thereof by using the wireless communication assembly 100 to possess a wireless communication function.

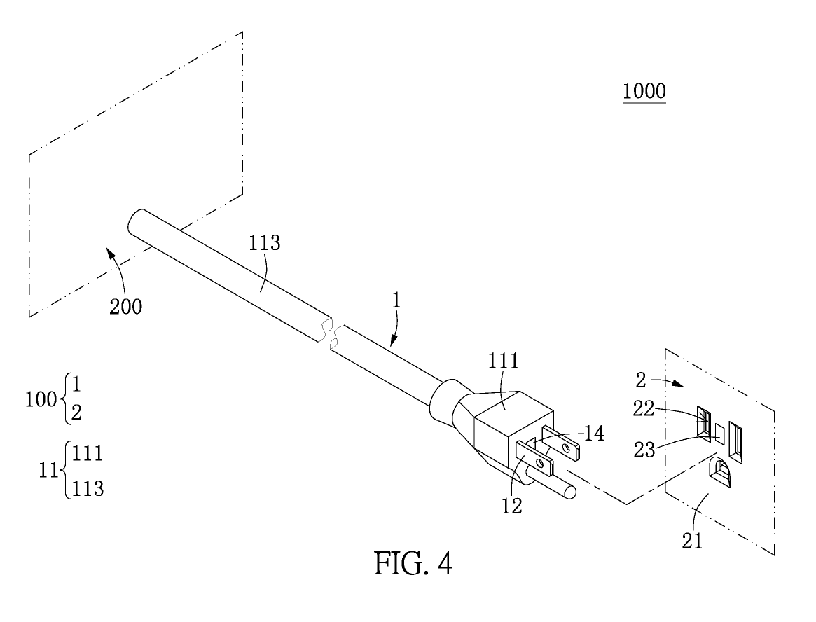

In addition, as shown in FIG. 4, the insulating body 11 of the power cord 1 can be provided without the wire connector 112. Specifically, an end of the insulating layer 113 arranged away from the plug 111 is connected to the household appliance 200, and the ends of the AC wire set 13 and the signal wire 15 arranged away from the plug 111 are connected to an interior component (e.g., a circuit board) of the household appliance 200.

As shown in FIGS. 1 and 3, the transceiver 14 and the communicator 23 in the present embodiment can be provided in an active transmission mode or a passive transmission mode. Specifically, for the active transmission mode, the transceiver 14 is configured to actively transmit the information about the household appliance 200 to the communicator 23, and the wireless module 24 is configured to transmit the information from the communicator 23 to the external electronic device E.

Moreover, for the passive transmission mode, the communicator 23 is configured to actively emit a detecting signal to the transceiver 14, the transceiver 14 transmits the information about the household appliance 200 to the communicator 23 after receiving the detecting signal, and the wireless module 24 is configured to transmit the information from the communicator 23 to the external electronic device E.

In addition, the transceiver 14 in the present embodiment is triggered by inserting the plug pins 12 into the socket pins 22 of the communication outlet 2. Specifically, when the communication outlet 2 transmits an AC power to the household appliance 200 through the power cord 1, the AC power is converted into a DC power to operate the transceiver 14. The transceiver 14 is preferably cooperated with the closest communicator 23 for achieving a better transmitting performance, but the present disclosure is not limited thereto.

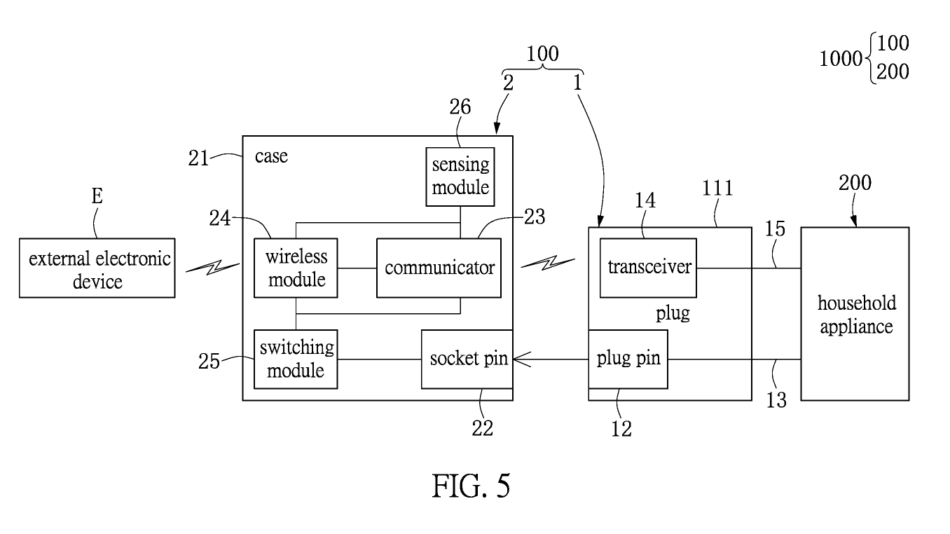

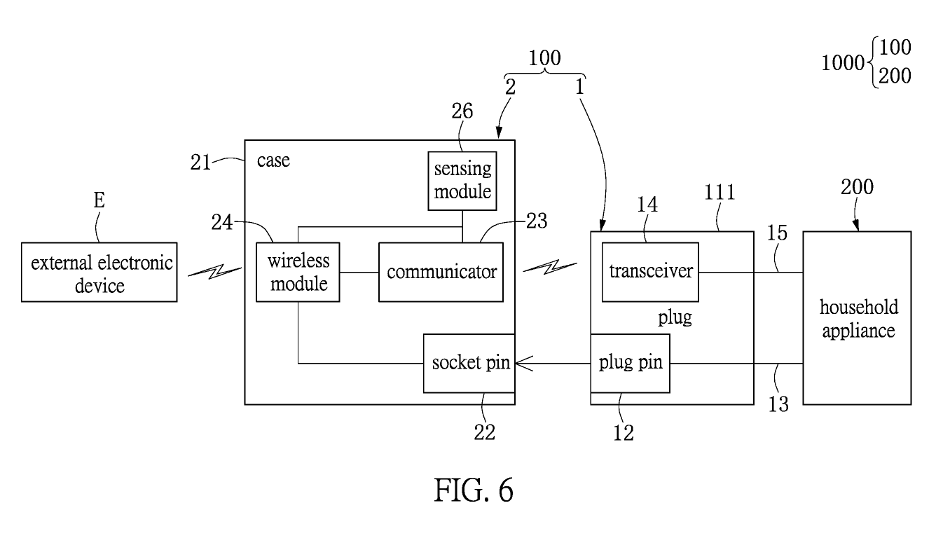

As shown in FIGS. 1 and 5, the communication outlet 2 includes a case 21, a sensing module 26, and a switching module 25, the latter two of which are arranged in the case 21. In the present embodiment, the socket pins 22, the communicator 23, and the wireless module 24 are approximately arranged in the case 21, and each of the communicator 23 and the wireless module 24 is preferably provided to partially expose from the case 21 (as shown in FIG. 3) for implementing the signal transmission function. In addition, the communication outlet 2 can be provided with one of the sensing module 26 and the switching module 25 (as shown in FIG. 6).

Specifically, the sensing module 26 is electrically connected to at least one of the communicator 23 and the wireless module 24. For example, the sensing module 26 in FIG. 5 is electrically connected to the communicator 23 and the wireless module 24. The sensing module 26 is configured to transmit a sensing signal to the household appliance 200 through the communicator 23, the transceiver 14, and the signal wire 15; or the sensing module 26 is configured to transmit a sensing signal to the external electronic device E through the wireless module 24. Moreover, the sensing module 26 in the present embodiment can be a temperature sensor, a humidity sensor, a gas sensor, a light sensor, or a combination thereof for detecting various environmental parameters (i.e., the sensing signal) related to the surroundings of the communication outlet 2.

Thus, the user or the household appliance 200 can get the environmental parameters by using the sensing module 26, so that the corresponding parameters of the household appliance 200 can be adjusted according to the environmental parameters by the user or itself, thereby maintaining a better operating performance of the household appliance 200.

Moreover, the socket pins 22 are respectively and detachably connected to the plug pins 12, and the switching module 25 is electrically connected to one of the socket pins 22. At least one of the wireless module 24 and the communicator 23 is electrically connected to the switching module 25 (i.e., FIG. 5 shows that both of the wireless module 24 and the communicator 23 are electrically connected to the switching module 25) and is configured to selectively trigger the switching module 25 for stopping to transmit the AC power from the communication outlet 2 to the power cord 1.

For example, after the household appliance 200 receives the sensing signal from the sensing module 26, the household appliance 200 can emit an instruction to the switching module 25 through the signal wire 15, the transceiver 14, and the communicator 23 according to the sensing signal. Or, when the user gets the sensing signal from the external electronic device E (e.g., a smart phone), the user can give an instruction to the switching module 25 through the wireless module 24 according to the sensing signal.

As shown in FIGS. 1 and 3, the transceiver 14 and the communicator 23 in the present embodiment can be arranged as follows. The transceiver 14 is substantially arranged in an area surroundingly defined by the plug pins 12, and the communicator 23 is substantially arranged in an area surroundingly defined by the socket pins 22. When the plug pins 12 are respectively inserted into the socket pins 22, the transceiver 14 and the communicator 23 face each other and preferably have a gap there-between, but the present disclosure is not limited thereto.

Thus, for the above arrangement of the transceiver 14 and the communicator 23, the power cord 1 and the communication outlet 2 can be formed with a smaller size, and the transceiver 14 and the communicator 23 can be operated in a directivity transmission (e.g., an infrared transmission), but the present disclosure is not limited thereto.

It should be noted that the external electronic device E is not included in the household appliance system 1000, but there are no distance limitations imposed between the external electronic device E and the household appliance system 1000. For example, the external electronic device E can be a touch panel arranged adjacent to the communication outlet 2 or installed in the case 21.

### The Effects of the Present Disclosure

In summary, the structure and connection of the power cord and the communication outlet in the present disclosure are improved to enable a household appliance (or a mating electronic device) which is connected to the power cord to possess a wireless communication function, so that the main structure of the household appliance (or the mating electronic device) can be maintained, and a user can control the household appliance (or the mating electronic device) easily.

Moreover, the wire connector of the power cord is detachably inserted into the inserting port of the household appliance, so that the ends of the AC wire set and the signal wire embedded in the wire connector can be electrically connected to the household appliance through the inserting port. Thus, the household appliance, which is similar to any conventional household appliance provided without wireless communication function, can increase its value without changing the main structure thereof by using the wireless communication assembly to possess a wireless communication function.

In addition, the user or the household appliance can get the environmental parameters related to the surroundings of the communication outlet by using the sensing module, so that the corresponding parameters of the household appliance can be adjusted according to the environmental parameters by the user or itself, thereby maintaining a better operating performance of the household appliance.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A wireless transmission assembly, comprising:
a power cord including:
a plug;
a plurality of plug pins each partially embedded in the plug;
an alternating current (AC) wire set having two opposite ends, wherein one of the two opposite ends of the AC wire set is embedded in the plug and is connected to the plug pins, and the other end of the AC wire set is configured to electrically connect to a mating electronic device;
a transceiver embedded in the plug; and
a signal wire having two opposite ends, wherein one of the two opposite ends of the signal wire is embedded in the plug and is electrically connected to the transceiver, and the other end of the signal wire is configured to electrically connect to the mating electronic device;
a communication outlet including:
a plurality of socket pins detachably connected to the plug pins for transmitting an AC power to the power cord;
a communicator arranged adjacent to the socket pins, wherein the communicator is configured to cooperate with the transceiver in a wireless signal connection for getting information about the mating electronic device; and
a wireless module electrically connected to the communicator, wherein the wireless module is configured to transmit the information from the communicator to an external electronic device.

2. The wireless transmission assembly as claimed in claim 1, wherein the transceiver is triggered by inserting the plug pins into the socket pins.

3. The wireless transmission assembly as claimed in claim 2, wherein the communicator is configured to actively emit a detecting signal to the transceiver, and the transceiver transmits the information about the mating electronic device to the communicator after receiving the detecting signal.

4. The wireless transmission assembly as claimed in claim 2, wherein the transceiver is configured to actively emit a detecting signal to the communicator.

5. The wireless transmission assembly as claimed in claim 1, wherein the transceiver is substantially arranged in an area surroundingly defined by the plug pins, the communicator is substantially arranged in an area surroundingly defined by the socket pins, and when the plug pins are respectively inserted into the socket pins, the transceiver and the communicator face each other.

6. The wireless transmission assembly as claimed in claim 1, wherein the communication outlet includes a switching module electrically connected to at least one of the socket pins, and at least one of the wireless module and the communicator is electrically connected to the switching module and configured to selectively trigger the switching module for stopping transmit the AC power from the communication outlet to the power cord.

7. The wireless transmission assembly as claimed in claim 1, wherein communication outlet includes a sensing module electrically connected to at least one of the communicator and the wireless module, the sensing module is configured to transmit a sensing signal to the mating electronic device through the communicator, the transceiver, and the signal wire; or the sensing module is configured to transmit a sensing signal to the external electronic device through the wireless module.

8. A household appliance system for being wirelessly connected to an external electronic device, comprising:
a household appliance; and
a wireless transmission assembly configured to wirelessly connect the household appliance to the external electronic device and including:
a power cord including:
a plug;
a plurality of plug pins each partially embedded in the plug;
an alternating current (AC) wire set having two opposite ends, wherein one of the two opposite ends of the AC wire set is embedded in the plug and is connected to the plug pins, and the other end of the AC wire set is configured to electrically connect to the household appliance;
a transceiver embedded in the plug; and
a signal wire having two opposite ends, wherein one of the two opposite ends of the signal wire is embedded in the plug and is electrically connected to the transceiver, and the other end of the signal wire is configured to electrically connect to the household appliance;
a communication outlet including:
a plurality of socket pins detachably connected to the plug pins;
a communicator arranged adjacent to the socket pins, wherein the communicator is configured to cooperate with the transceiver in a wireless signal connection for getting information about the household appliance; and
a wireless module electrically connected to the communicator, wherein the wireless module is configured to transmit the information from the communicator to the external electronic device.

9. The household appliance system as claimed in claim 8, wherein the transceiver is triggered by inserting the plug pins into the socket pins.

10. The household appliance system as claimed in claim 8, wherein the household appliance includes an inserting port, the power cord includes an wire connector arranged away from the plug, the wire connector is detachably inserted into the inserting port, and the ends of the AC wire set and the signal wire arranged away from the plug are embedded in the wire connector so as to electrically connect to the household appliance through the inserting port.
